(19) United States
(12) Patent Application Publication
(10) Pub. No.: US 2026/0323146 A1
(43) Pub. Date: Oct. 15, 2026

(54) CAMERA ASSEMBLY

(71) Applicant: Luxshare Intelligent Manufacture Technology (Changshu) Co., Ltd., Changshu City (CN)

(72) Inventors: ChenYu Yu, Changshu City (CN); ChiaTan Huang, Changshu City (CN); QiQing Ruan, Changshu City (CN); ShihPing Lin, Changshu City (CN); WenYen Huang, Changshu City (CN)

(73) Assignee: Luxshare Intelligent Manufacture Technology (Changshu) Co., Ltd., Changshu City (CN)

(21) Appl. No.: 19/567,562

(22) Filed: Mar. 16, 2026

(30) Foreign Application Priority Data
Apr. 14, 2025 (CN) 202510465522.7

(51) Int. Cl. H04N 23/54; H04N 23/51; H04N 23/55

(52) U.S. Cl. CPC H04N 23/54; H04N 23/51; H04N 23/55

(57) ABSTRACT

The embodiment of the invention discloses a lens assembly and a lens module, an elastic part and a lens are arranged on a lens mounting seat, a first connecting area of the elastic part is used for being fixedly connected with the lens mounting seat, and a second connecting area of the elastic part is used for being fixedly connected with an inner side area of the lens module, so that the lens mounting seat is hung in the lens module. Meanwhile, the moving distance of the lens in the lens module can be limited by utilizing the stop part. Therefore, the backstop part is configured to extend out of the hollow area, so that the backstop part can avoid the elastic part. And meanwhile, the first reinforcing layer is arranged between the stopping part and the edge of the laying surface, so that the mechanical strength of the edge position of the body can be improved in a targeted manner. And on the other hand, in the process that the lens mounting seat moves upwards, the elastic part is bent and deformed. Therefore, the first reinforcing layer is configured to be opposite to the hollow area, so that the first reinforcing layer can avoid the elastic part, and collision between the first reinforcing layer and the elastic part is avoided.

### CLAIM OF PRIORITY AND CROSS-REFERENCE TO RELATED APPLICATION(S)

This application claims the benefit of Chinese Patent Application No. 202510465522.7, filed on Apr. 14, 2025, which is incorporated herein by reference in its entirety.

### BACKGROUND OF THE DISCLOSURE

### 1. Field of the Disclosure

The present disclosure relates to the field of camera equipment, and particularly to a camera assembly.

### 2. Description of the Related Art

Consumer electronic devices such as smartphones, tablet computers, and notebook computers typically include one or more embedded cameras, which allow users to capture digital images, videos, or both. For example, a smartphone may be equipped with a pair of cameras, including a rear-facing camera for capturing scenes behind the phone and a front-facing camera for capturing scenes in front of the phone. Users may access a camera application on the phone to activate one of the cameras, view a real-time display of the image sensed by the camera (e.g., a virtual viewfinder), and select controls to capture and store images or videos. The rear-facing camera is sometimes used as a “point-and-shoot” camera to capture images of the scene in front of the user, while the front-facing camera is often used for taking photos or videos of the user holding the device with the camera embedded, such as for “selfies” or live video conferencing. Some devices place the front-facing camera assembly within the bezel surrounding the main display component of the device, such as the bezel around the touchscreen of a smartphone.

In current camera assemblies, the image sensor is fixed on the base, the lens assembly is fixed on the carrier, the carrier may move within the shell above the base, and a top cover is placed outside the shell, carrier, and lens assembly. Light needs to first pass through a hole in the top cover to enter the lens assembly and then reach the image sensor. The hole on the top cover may be made sufficiently large to ensure it does not become a limiting factor for light entry. Furthermore, the above structure requires multiple active alignments for various components, which imposes high requirements, results in numerous steps in the assembly process, and makes it difficult to ensure assembly precision.

### BRIEF DESCRIPTION OF THE DISCLOSURE

In view of this, embodiments of the present disclosure provide a camera assembly, simplifying the assembly process and improving production efficiency as well as the quality of the final product.

Embodiments of the present disclosure provide a camera assembly, the camera assembly including: a base; an outer shell, connected to the base, the base and the outer shell enclosing to form an accommodation cavity; a lens assembly, fixed in a central opening of the outer shell; a carrier, slidably disposed in the accommodation cavity; an image sensor, located within the accommodation cavity, the image sensor fixed on a side of the carrier close to the base, the lens assembly and the image sensor being coaxially arranged; a magnet, located on a first lateral outer side surface of the carrier; a wire coil, located on a first lateral inner side surface of the outer shell, and arranged opposite to the magnet on the first lateral outer side surface of the carrier; a driving module, located below the base, the driving module electrically coupled to the wire coil.

### BRIEF DESCRIPTION OF THE DRAWINGS

Through the description of embodiments of the present disclosure with reference to the accompanying drawings below, the above and other objects, features, and advantages of the present disclosure will become more apparent. In the drawings:

FIG. 1 is a schematic structural diagram of a camera assembly according to an embodiment of the present disclosure;

FIG. 2 is a cross-sectional view of the camera assembly according to an embodiment of the present disclosure;

FIG. 3 is an exploded view of the camera assembly according to an embodiment of the present disclosure;

FIG. 4 is a schematic structural diagram of a base according to an embodiment of the present disclosure;

FIG. 5 is a top view of the base according to an embodiment of the present disclosure;

FIG. 6 is a cross-sectional view of an outer shell connected to the base according to an embodiment of the present disclosure;

FIG. 7 is a schematic structural diagram of a magnet and balls installed on a carrier according to an embodiment of the present disclosure;

FIG. 8 is a schematic diagram of the relative position of the carrier and the base according to an embodiment of the present disclosure;

FIG. 9 is a schematic diagram of the camera assembly not connected to a base plate according to an embodiment of the present disclosure;

FIG. 10 is a schematic diagram of a wire coil installed on a fixing member according to an embodiment of the present disclosure;

FIG. 11 is a schematic structural diagram of an outer shell according to an embodiment of the present disclosure;

FIG. 12 is a schematic structural diagram of a driving module according to an embodiment of the present disclosure.

### DETAILED DESCRIPTION OF EMBODIMENTS OF THE DISCLOSURE

Embodiments of the present application are described below based on examples, but the present application is not limited to these examples. In the detailed description of the present application below, some specific details are described in detail. Those skilled in the art may fully understand the present application without the description of these details. To avoid obscuring the essence of the present application, well-known methods, procedures, processes, elements, and circuits are not described in detail.

Furthermore, it should be understood by those of ordinary skill in the art that the accompanying drawings provided herein are for illustrative purposes only, and the drawings are not necessarily drawn to scale.

Unless otherwise explicitly specified and defined, terms such as “installed,” “connected,” “coupled,” and “fixed” should be interpreted broadly. For example, it may be a fixed connection, a detachable connection, or an integral connection; it may be a mechanical connection, an electrical connection; it may be a direct connection, or an indirect connection through an intermediary; it may be the internal communication between two elements or the interaction relationship between two elements, unless otherwise explicitly defined. For those of ordinary skill in the art, the specific meanings of the above terms in the present application may be understood based on specific circumstances.

Unless the context clearly requires otherwise, throughout the description and claims of this application, words such as “comprising,” “including,” and similar terms are to be interpreted in an inclusive sense as opposed to an exclusive or exhaustive sense; that is to say, in the sense of “including but not limited to.”

In the description of the present application, it should be understood that terms such as “first” and “second” are used for descriptive purposes only and cannot be understood as indicating or implying relative importance. Furthermore, in the description of the present application, unless otherwise specified, “a plurality of” means two or more.

The present application describes a camera assembly that enables movement of the lens assembly relative to the image sensor to provide autofocus capability. In some implementations, the camera assembly is configured to be embedded in an electronic device or a display component, such as embedded in a smartphone, tablet computer, television, or computer monitor. The camera assembly may be installed near the top edge of the display screen, for example, within the bezel forming the periphery of the screen.

As shown in FIGS. 1-3, the camera assembly includes a base 1, an outer shell 2, a lens assembly 3, a carrier 4, an image sensor 5, a voice coil motor 400, and a driving module 300. The outer shell 2 is connected to the base 1, the base 1 and the outer shell 2 enclose to form an accommodation cavity 10, which may be used to support the carrier 4, image sensor 5, and voice coil motor 400. The driving module 300 is located below the base 1, and the driving module 300 is electrically coupled to the wire coil 7.

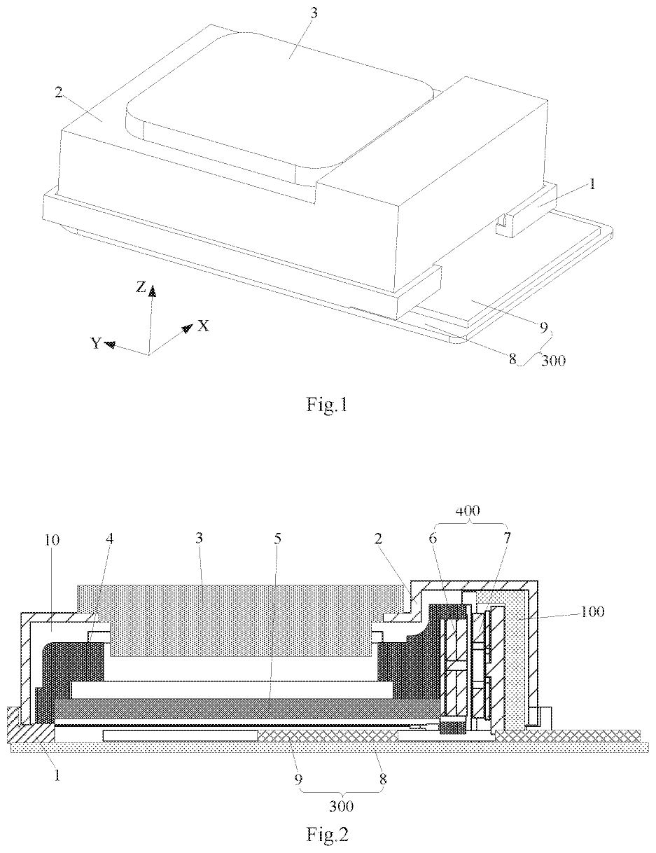

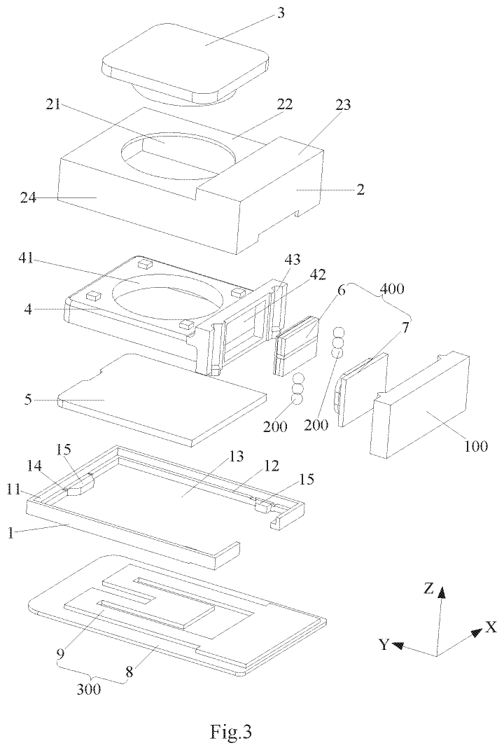

As shown in FIGS. 2 and 3, the outer shell 2 is provided with a central opening 21, and the lens assembly 3 is fixed in the central opening 21 of the outer shell 2. The size of the central opening 21 matches the size of the lens assembly 3 so that the lens assembly 3 may be fixed in the central opening 21. The lens assembly 3 may include one or more lenses that may interact to focus light onto the image sensor 5.

The carrier 4 is received within the accommodation cavity 10 and is laterally fixed (along the x and y axes) within the accommodation cavity 10 during assembly. The carrier 4 may slide within the accommodation cavity 10 along the vertical direction (along the z-axis, also referred to as the “optical axis”). The image sensor 5 may be installed on the carrier 4. In some implementations, the image sensor 5 is located within the accommodation cavity 10, the image sensor 5 is fixed on a side of the carrier 4 close to the base 1, and the lens assembly 3 and the image sensor 5 are coaxially aligned along the optical axis. The carrier 4 may carry the image sensor 5 to slide within the accommodation cavity 10 along the vertical direction, changing the distance between the image sensor 5 and the lens assembly 3, thereby adjusting the focus of the camera assembly.

In the present application, by directly fixing the lens assembly 3 in the central opening 21 of the outer shell 2, light passes directly through the lens assembly 3 to reach the image sensor 5, ensuring that under any circumstances it will not obstruct the normal passage of light. In the prior art, light needs to first pass through a hole in the top cover to enter the lens assembly and then reach the image sensor 5, and the hole on the top cover may be made sufficiently large to ensure it does not become a limiting factor for light entry (i.e., does not block the field of view of the lens).

Furthermore, the image sensor 5 is installed on the carrier 4 and driven synchronously, which may reduce the height of the camera assembly. At the same time, directly fixing the lens assembly 3 in the central opening 21 of the outer shell 2 avoids the need to increase the aperture to meet the requirement for light entry, thereby reducing the area of the camera assembly and thus shrinking the overall volume of the camera assembly. Meanwhile, in the prior art, the lens assembly, carrier, and image sensor need to be arranged sequentially, requiring multiple active alignments with high requirements. In the present application, the outer shell and the lens assembly are first set in a fixed state. During assembly, it only needs to ensure that the image sensor and the lens assembly achieve coaxial alignment of the optical axis to ensure assembly precision, which is more conducive to optimization of the assembly process.

The voice coil motor 400 drives the carrier 4 and the image sensor 5 to move along the optical axis of the camera to adjust the distance from the image sensor 5 to the lens assembly, thereby achieving autofocus capability. In some embodiments, the voice coil motor 400 is disposed between the outer side surface of the carrier 4 and the inner side surface of the outer shell 2, and the voice coil motor 400 is used to drive the carrier 4 to move along the vertical direction when energized.

As shown in FIGS. 2 and 3, the voice coil motor 400 includes a magnet 6 and a wire coil 7. The magnet 6 is located on a first lateral outer side surface of the carrier 4. The wire coil 7 is located on a first lateral inner side surface of the outer shell 2. The magnet 6 and the wire coil 7 are arranged opposite to each other in the camera assembly. Due to the close proximity between the magnet 6 and the wire coil 7, a current may be applied to the wire coil 7 to generate a magnetic field that interacts with the magnetic field of the magnet 6. The attractive or repulsive force between the magnetic fields drives the carrier 4 and the image sensor 5 upward or downward within the accommodation cavity 10 (along the optical axis). Optionally, the carrier 4 further comprises a first mounting groove 42, the first mounting groove 42 disposed on the first lateral outer side surface of the carrier 4, and the magnet 6 is installed in the first mounting groove 42, so that changes in the magnetic field of the magnet 6 drive the movement of the carrier 4.

As shown in FIGS. 1-3, the driving module 300 includes a base plate 8 and a driver circuit 9. The driver circuit 9 is installed on the base plate 8. The base plate 8 is located below the base 1. The driver circuit 9 is electrically coupled to the image sensor 5 and the wire coil 7, respectively. The driver circuit 9, such as a driver IC, delivers power to the wire coil 7 to energize the wire coil 7 and generate a second magnetic field that interacts with the magnetic field of the magnet 6. The driver IC may energize the wire coil 7 in response to control signals provided to the driver IC from an external controller, such as a microprocessor or other data processing device. In some implementations, the driver IC may adjust the magnetic field emitted from the wire coil 7 to drive the carrier 4 upward or downward to a precise position, for example, by reversing the direction of the current delivered to the wire coil 7 (thereby reversing the polarity of the magnetic field emitted from the wire coil 7) and adjusting the effective strength of the magnetic field (e.g., using pulse width modulation) to adjust the amount of attractive or repulsive force between the magnet 6 and the wire coil 7, thereby causing the magnet 6 to move the image sensor 5 up and down via the carrier 4. The image sensor 5 may feed back the detected image information through the driver circuit 9 to control modules of the camera assembly, etc. Furthermore, the driver circuit 9 also has an elastic function, which may help the image sensor 5 reset after movement and make the image sensor 5 more stable during up and down movement.

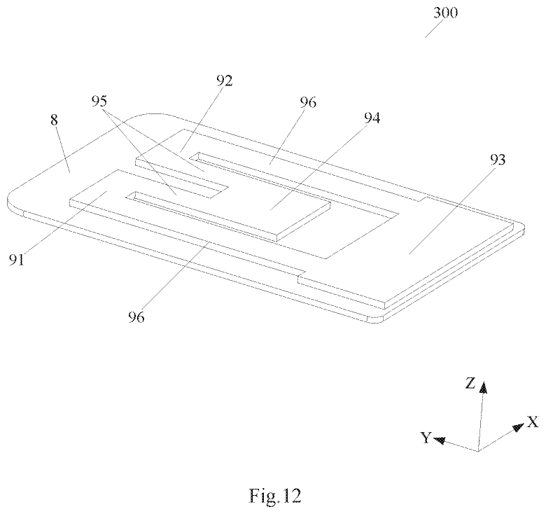

In one embodiment, as shown in FIG. 12, the driver circuit 9 includes a first fixed end 91, a second fixed end 92, a third fixed end 93, and a movable end 94. The third fixed end 93 and the movable end 94 are arranged opposite to each other along a first lateral direction Y. The first fixed end 91 and the second fixed end 92 are arranged opposite to each other along a second lateral direction X and are disposed on a side of the movable end 94 away from the third fixed end 93. The length of the third fixed end 93 along the second lateral direction X is greater than the length of the movable end 94, and its two ends extend beyond the outer sides of the movable end 94. The outer ends of the first fixed end 91 and the second fixed end 92 along the second lateral direction X extend beyond the outer sides of the movable end 94. One end of the first fixed end 91 and one end of the second fixed end 92 are respectively connected to two ends of the movable end 94 via a first connecting segment 95. The other end of the first fixed end 91 and the other end of the second fixed end 92 are respectively connected to two ends of the third fixed end 93 via a second connecting segment 96. The two first connecting segments 95 are parallel, and the two second connecting segments 96 are respectively arranged parallel to the two first connecting segments 95 on their outer sides, thereby forming the driver circuit 9 into a square-loop shape. The first fixed end 91, the second fixed end 92, and the third fixed end 93 are fixed on the base plate 8. The movable end 94 is electrically coupled to the image sensor 5 and the wire coil 7, respectively. This allows the driver circuit 9 to enhance connection stability while also improving the stability of resetting and up/down movement for the image sensor 5.

In one embodiment, the outer shell 2 includes a first top surface 22, a second top surface 23, and an annular side surface 24, as shown in FIGS. 3 and 11. The first top surface 22 and the second top surface 23 are parallel and adjacently arranged along the left-right direction (i.e., the Y-axis). The second top surface 23 is higher than the first top surface 22, and the first top surface 22 and the second top surface 23 are connected via a vertical surface. The annular side surface 24 extends vertically downward from the edges of the first top surface 22 and the second top surface 23, and the annular side surface 24 extends to the same horizontal line, forming a box structure with a downward opening, as shown in FIGS. 3 and 11. Setting the outer shell 2 as a box structure with a downward opening allows it to cover the outside of the carrier 4, image sensor 5, and voice coil motor 400, forming a physical barrier to protect the internal components of the camera assembly from external forces and hazards. Furthermore, the first top surface 22 of the outer shell 2 is provided with a central opening 21 for installing and fixing the lens assembly 3, facilitating the collection of a wider range of external light, allowing the image sensor to capture images with a broader field of view. Optionally, the first top surface 22 and the second top surface 23 are rectangular, and the annular side surface 24 is formed by four rectangles sequentially connected, thus making the outer shell 2 a rectangular box structure with a downward opening.

Additionally, in some implementations, the outer shell 2 is at least partially formed of a metal material and is used to shield the camera assembly from electromagnetic interference (EMI) that may occur in the environment.

After the outer shell 2 with the above structure is connected to the base 1, the enclosed accommodation cavity 10 includes two parts: a first accommodation portion 101 and a second accommodation portion 102 that are connected laterally. The second accommodation portion 102 is higher than the first accommodation portion 101. The second accommodation portion 102 corresponds to being located below the second top surface 23, and the first accommodation portion 101 corresponds to being located below the first top surface 22.

As shown in FIGS. 3 and 7, the carrier 4 includes a moving through hole 41. The moving through hole 41 longitudinally penetrates through the carrier 4, and the image sensor 5 is located below the moving through hole 41. The lens assembly 3 is located above the moving through hole 41. This allows light to pass through the lens assembly 3 and then through the moving through hole 41 to reach the image sensor 5, obtaining an image. The outer diameter of the lens assembly 3 is smaller than the aperture of the moving through hole 41, which allows the carrier 4 carrying the image sensor 5 to move, causing the lens assembly 3 to slide relative to the moving through hole 41 of the carrier over a distance, improving the focusing range.

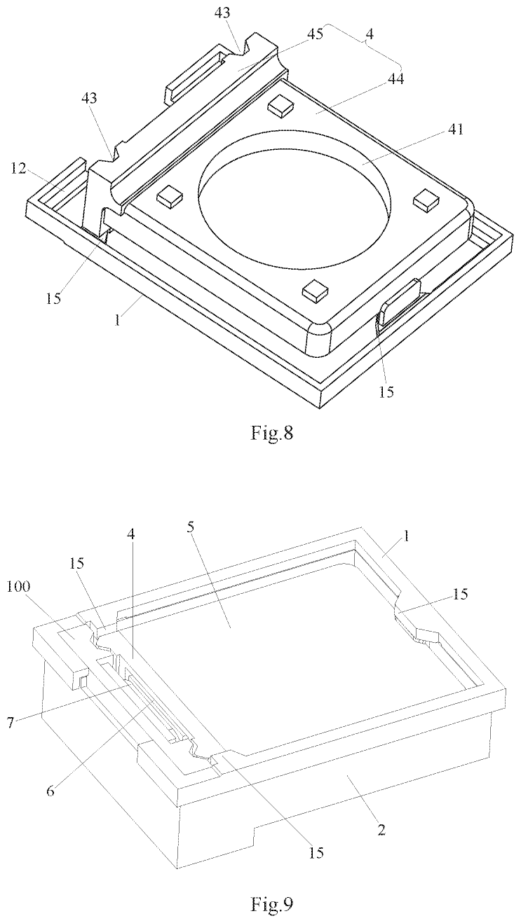

As shown in FIGS. 7 and 8, the carrier 4 includes a main body portion 44 and an auxiliary portion 45. The auxiliary portion 45 is higher than the main body portion 44. The moving through hole 41 is disposed on the main body portion 44. The image sensor 5 is fixed on the main body portion 44 on the side away from the lens assembly 3, and the image sensor 5 is located directly below the moving through hole 41. The main body portion 44 and the image sensor 5 are located within the first accommodation portion 101. The auxiliary portion 45 and the voice coil motor 400 (i.e., the magnet 6 and wire coil 7) are located within the second accommodation portion 102. This arrangement satisfies the vertical movement of the carrier 4 while also keeping the voice coil motor 400 and the image sensor 5 in non-interfering positions. The first mounting groove 42 is disposed on the outer side surface of the auxiliary portion 45, and the magnet 6 is fixed in the first mounting groove 42 of the auxiliary portion 45.

Optionally, a protrusion is convexly provided on a side of the main body portion 44 opposite to the lens assembly, and the protrusion is arranged opposite to the auxiliary portion 45. The image sensor 5 is provided with a positioning groove. The image sensor 5 is installed between the auxiliary portion 45 and the protrusion, with the protrusion limited within the positioning groove, thereby fixing the image sensor 5. Optionally, the top surface of the main body portion 44 is provided with an anti-collision block, so that when the carrier 4 moves upward, the main body portion 44 contacts the outer shell 2 via the anti-collision block, preventing damage to the main body portion 44.

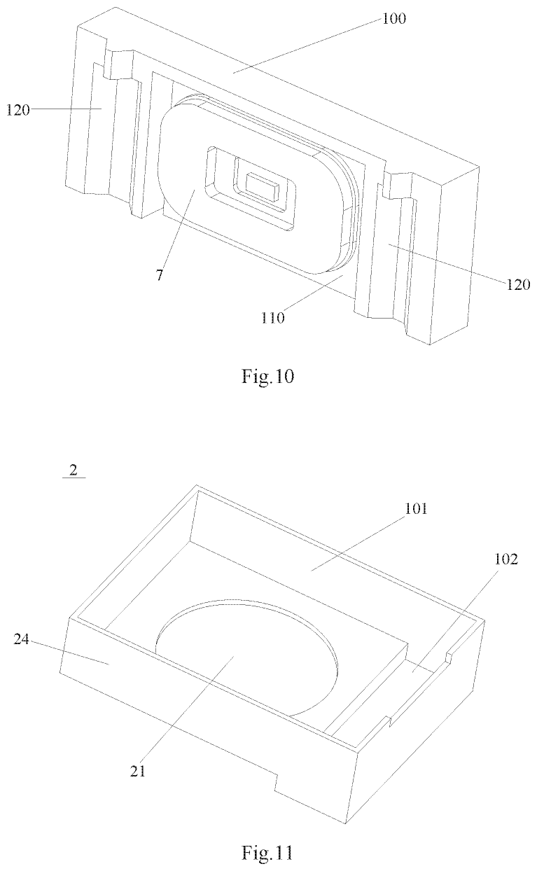

As shown in FIGS. 2 and 9, the camera assembly further includes a fixing member 100. The fixing member 100 is installed within the accommodation cavity 10 and located outside the first lateral outer side surface of the carrier 4. The fixing member 100 is used to receive and fix the wire coil 7. Specifically, the fixing member 100 is installed within the second accommodation portion 102 and has a second mounting groove 110 with an opening facing the side of the carrier 4. As shown in FIG. 10, the wire coil 7 is fixed in the second mounting groove 110, thereby achieving an opposite arrangement with the magnet 6, and subsequently completing the driving of the carrier 4.

In some embodiments, the camera assembly further includes one or more stacked balls 200, as shown in FIGS. 3 and 7. The balls 200 are arranged between the outer side surface of the carrier 4 and the inner side surface of the outer shell 2. The carrier 4 linearly slides within the accommodation cavity 10 via the balls 200, which may reduce friction and improve sliding smoothness. For example, the stacked balls 200 are partially enclosed within the carrier 4, and a portion may protrude beyond the defined plane.

A first sliding groove 43 is further provided on the first lateral outer side surface of the carrier 4 (i.e., the auxiliary portion 45), and the fixing member 100 is provided with a second sliding groove 120. The first sliding groove 43 and the second sliding groove 120 are arranged opposite to each other, as shown in FIGS. 7 and 10. The balls 200 are rollably disposed in the first sliding groove 43 and the second sliding groove 120, thereby achieving the sliding of the carrier 4. A bottom limiting member is provided at the bottom end of the first sliding groove 43, and a top limiting member is provided at the top end of the second sliding groove 120. When the carrier 4 and the fixing member 100 are installed within the accommodation cavity 10, the bottom limiting member may partially extend into the second sliding groove 120, and the top limiting member may partially extend into the first sliding groove 43, thereby achieving upper and lower limitation on the balls 200 and preventing them from falling out.

In some implementations, the magnet 6 is a permanent magnet (e.g., ceramic, ferrite, neodymium iron boron, samarium cobalt, or alnico), but in other implementations, the magnet may be an electromagnet requiring current to excite a magnetic field. The magnet 6 is part of the voice coil motor 400, and the magnetic field it emits is partially utilized to physically drive the carrier up and down. Particularly, in the assembled camera assembly, the magnet 6 is positioned adjacent to the wire coil 7 to allow the respective magnetic fields emitted by the magnet 6 and the wire coil 7 to interact when the wire coil 7 is energized.

In some implementations, the image sensor 5 is a charge-coupled device (CCD). In other implementations, the image sensor is a complementary metal-oxide-semiconductor (CMOS) sensor. The image projected onto the image sensor may, for example, be captured, stored, and/or presented to the user.

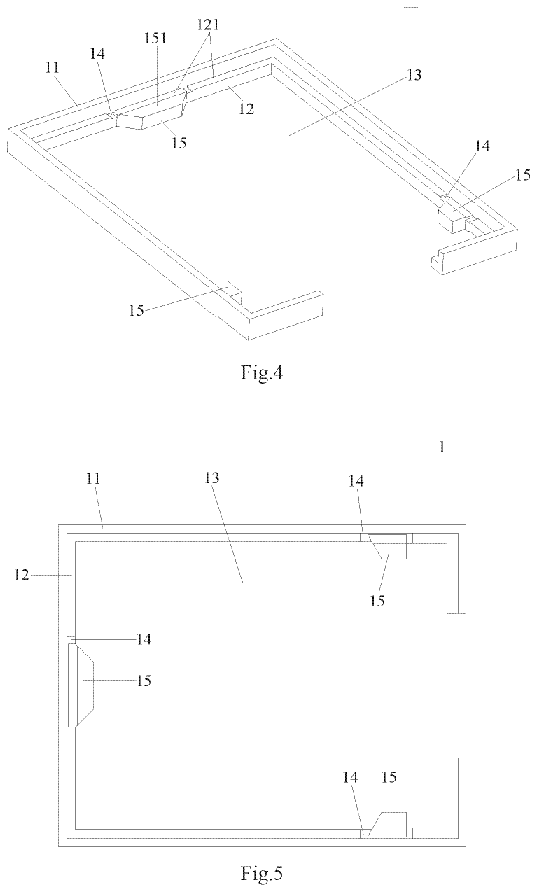

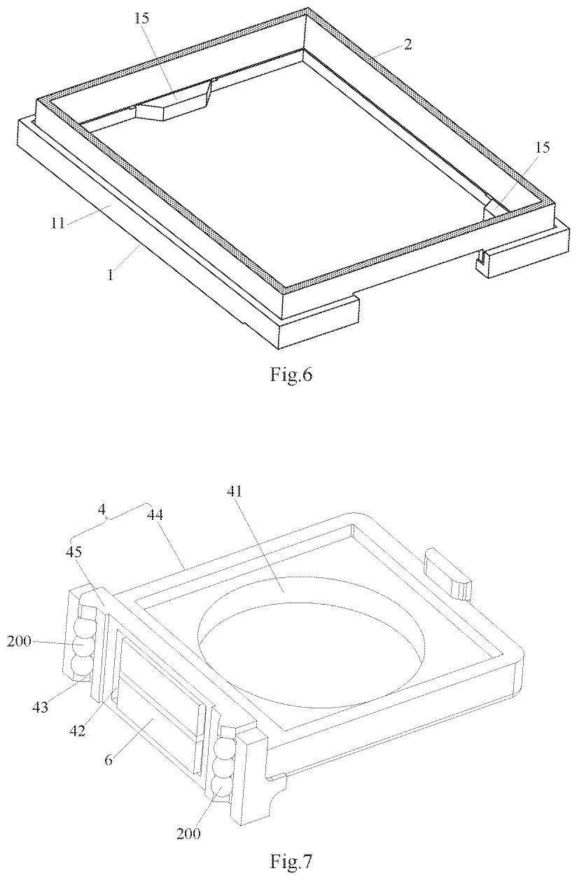

In one embodiment, the base 1 includes a bottom portion 12 and a side wall 11 disposed on the bottom portion 12, as shown in FIGS. 4 and 5. As shown in FIG. 6, the side wall 11 extends around the periphery of the outer shell 2 (i.e., the annular side surface 24), allowing the bottom surface of the outer shell 2 to be connected via adhesive to the bottom portion 12 of the base 1, with the side wall 11 surrounding the outside of the annular side surface 24 in the horizontal direction (i.e., the X-axis and Y-axis). The connection method between the outer shell 2 and the base 1 may make the connection more secure. At the same time, the base 1 may provide a more accurate installation position for the outer shell 2, allowing the lens assembly 3 on the outer shell 2 and the internal image sensor 5 to quickly achieve coaxial alignment of the optical axis. The bottom portion 12 has a mounting opening 13 located in the middle of the bottom portion 12. The size of the mounting opening 13 is smaller than the inner size of the side wall 11, exposing a certain width of the bottom portion 12 to receive the outer shell 2, reducing manufacturing difficulty and increasing product stability. The mounting opening 13 allows the voice coil motor 400 to achieve electrical connection, etc., with the external driver circuit 9.

In one embodiment, the bottom portion 12 is provided with an adhesive accommodating groove 14, formed by recessing downward from the upper surface of the bottom portion 12, as shown in FIGS. 4 and 5. The adhesive accommodating groove 14 is used to store a small amount of adhesive during the bonding of the outer shell 2 and the base 1, preventing adhesive overflow, reducing product defect rates, and ensuring product functional characteristics. The shape, quantity, and position of the adhesive accommodating groove 14 are not limited and may be set according to practical conditions. Optionally, the adhesive accommodating groove 14 is set as a U-shaped groove, with both ends of the U-shaped groove communicating with the mounting opening 13. The middle part of the U-shaped groove is close to the side wall 11, allowing excess adhesive on both the inside and outside of the outer shell 2 to be squeezed into the adhesive accommodating groove 14.

As shown in FIGS. 4 and 5, the base 1 further comprises a limiting block 15. One end of the limiting block 15 is connected to the inner side surface of the bottom portion 12, and the other end extends towards the interior of the mounting opening 13. The limiting block 15 is used to support the carrier 4, preventing the carrier 4 from moving out of the accommodation cavity 10. Also, the limiting block 15 is used to limit the downward movement of the carrier 4. When the carrier 4 moves to the lowest position, the bottom surface of the carrier 4 contacts and abuts against the limiting top surface 151 (i.e., the upper surface) of the limiting block 15. Optionally, the limiting top surface 151 of the limiting block 15 is higher than the connecting top surface 121 of the bottom portion 12. This makes the area of the limiting block 15 relatively small, making it easier to control its flatness, so that when the carrier 4 contacts it, it may still maintain coaxial alignment of the optical axis with the lens assembly 3. At the same time, the limiting block 15 may prevent adhesive from being squeezed onto the surface of the limiting block 15 during the connection of the outer shell and the base 1, which could affect the movement of the carrier 4.

In some embodiments, the adhesive accommodating groove 14 is adjacently arranged to the limiting block 15, with the two open ends of the U-shaped groove located on two sides of the limiting block 15, which may store adhesive near the limiting block 15, preventing excess adhesive from overflowing onto the limiting block 15.

In some embodiments, the limiting block 15 is set as an isosceles trapezoid, which may achieve force balance when the carrier 4 contacts it, preventing corners from lifting. In addition, the limiting block 15 may also be set as a right-angled trapezoid, etc. The shape, quantity, and position of the limiting block 15 are not limited and may be set according to practical conditions. Optionally, the limiting block 15 may also be disposed on the base plate 8, etc. The quantity and distribution position of the limiting block(s) 15 should enable stable support of the carrier 4.

The camera assembly of this embodiment includes a base, an outer shell, a lens assembly, a carrier, an image sensor, a magnet, a wire coil, and a driving module. The base and the outer shell enclose to form an accommodation cavity. The lens assembly is fixed in a central opening of the outer shell. The image sensor is fixed on a side of the carrier close to the base and is slidably disposed in the accommodation cavity such that the lens assembly and the image sensor are coaxially arranged. The magnet is located on a first lateral outer side surface of the carrier. The wire coil is located on a first lateral inner side surface of the outer shell and is arranged opposite to the magnet. The driving module is located below the base, and the driving module is electrically coupled to the wire coil. By fixing the lens assembly on the outer shell and installing the image sensor on the carrier, the camera assembly may avoid the need to increase the aperture to meet the requirement for light entry, thereby reducing the area of the camera assembly and shrinking the overall volume of the camera assembly. At the same time, during assembly, it only needs to ensure that the image sensor and the lens assembly achieve coaxial alignment of the optical axis when the carrier and the outer shell are installed, thereby ensuring assembly precision, improving production efficiency, and enhancing the quality of the final product.

The above descriptions are only preferred embodiments of the present application and are not intended to limit the present application. For those skilled in the art, the present application may have various modifications and changes. Any modifications, equivalent replacements, improvements, etc., made within the spirit and principles of the present application may be included within the protection scope of the present application.

1. An actuator for adjusting a focus in a camera, the actuator comprising:
case;
A carrier module that is slidably received in a central opening of the housing, the carrier module is configured to carry a lens assembly of the camera;
A magnet on a first lateral side of the carrier module;
A wire coil located on or along the first lateral side of the housing and adjacent to the magnet on the first lateral side of the carrier module;
A driver circuit located on or along a second lateral side of the housing opposite to the first lateral side of the housing; and
A connector member extending from a first region near the first lateral side of the housing to a second region near the second lateral side of the housing, the connector member It includes at least one conductor configured to pass a current from the driver circuit to the wire coil to excite the wire coil.

2. The actuator according to claim 1, wherein:
The magnet on the first lateral side of the carrier module is configured to generate a first magnetic field;
The wire coil is configured to generate a second magnetic field when excited; and
The carrier is configured to slide within the central opening of the housing to a result of an interaction of the first magnetic field generated by the magnet and the second magnetic field generated by an excited wire coil. position.

3. The actuator according to claim 1 or 2, wherein the magnet on the first lateral side of the carrier module includes a permanent magnet.

4. An actuator according to any one of the preceding claims, wherein the connector part comprises a rigid-flex printed circuit board, and the at least one conductor of the connector part comprises at least one arranged on the rigid-flex Conductive traces on or in a printed circuit board.

5. An actuator according to any one of the preceding claims, wherein the driver circuit comprises a driver integrated circuit configured to receive a control from a controller indicating an activation state to be applied to the wire coil Signal, and the driver integrated circuit is configured to pass the current to the wire coil to excite the wire coil according to the activation state indicated by the control signal.

6. An actuator according to any one of the preceding claims, wherein the actuator is configured to be perpendicular to the first lateral side and the second lateral side of the housing along respective axes The ground-extending orientation is embedded in a computing device or electronic display assembly, and the shaft extends between the top of the computing device or electronic display assembly and the bottom of the computing device or electronic display assembly.

7. The actuator according to any one of the preceding claims, further comprising a position sensor located on or along the second lateral side of the housing, so The position sensor is configured to sense the current position of the carrier module from a range of possible positions within which the carrier module can slide into the central opening of the housing.

8. The actuator of claim 7, wherein the position sensor comprises a Hall effect sensor located on or along a second lateral side of the housing, and
The actuator further includes a second magnet on a second lateral side of the carrier module opposite to the first lateral side of the carrier module, the second magnet and The Hall effect sensors are adjacent to allow the Hall effect sensor to sense the motion of the second magnet generated when the carrier module slides within the central opening of the housing.

9. The actuator according to any one of the preceding claims, further comprising a stack of one or more balls, the stack of one or more balls being arranged to facilitate the placement of the carrier module in the housing. The linear sliding motion in the center opening is described.

10. An actuator according to any one of the preceding claims, wherein the wire coil is mounted on a first printed circuit board positioned along the first lateral side of the housing.

11. The actuator of claim 10, wherein the driver circuit is mounted on a second printed circuit board positioned along the second lateral side of the housing.

12. The actuator according to claim 11, wherein the connector part extends from the first printed circuit board on which the wire coil is mounted to the second printed circuit board on which the driver circuit is mounted.

13. A camera including:
Actuator, including
case;
A carrier module that is slidably received in a central opening of the housing, the carrier module is configured to carry a lens assembly of the camera;
A magnet on a first lateral side of the carrier module;
A wire coil located on or along the first lateral side of the housing and adjacent to the magnet on the first lateral side of the carrier module;
A driver circuit located on or along a second lateral side of the housing opposite to the first lateral side of the housing; and
A connector member extending from a first region near the first lateral side of the housing to a second region near the second lateral side of the housing, the connector member Including at least one conductor configured to pass a current from the driver circuit to the wire coil to excite the wire coil;
The lens assembly, wherein the lens assembly is at least partially fixed within the carrier module of the actuator;
An image sensor in a fixed position relative to the housing of the actuator, wherein one or more lenses of the lens assembly are configured to direct external light through a hole and reach the image sensor surface;
Wherein the camera is configured to, when the current passed from the driver circuit to the wire coil is adjusted, move the bearing along an optical axis extending through one or more lenses and the image sensor Lens module and the lens assembly to adjust the focus.

14. A computing device includes:
Electronic display
Camera, including:
Actuator, including
case;
A carrier module, slidably received in a central opening of the housing, the carrier module is configured to carry a lens assembly of the camera;
A magnet on a first lateral side of the carrier module;
A wire coil located on or along a first lateral side of the housing and adjacent to a magnet on the first lateral side of the carrier module;
A driver circuit located on or along a second lateral side of the housing opposite the first lateral side of the housing; and
A connector member extending from a first region near the first lateral side of the housing to a second region near the second lateral side of the housing, the connector member Including at least one conductor configured to pass a current from the driver circuit to the wire coil to excite the wire coil;
The lens assembly, wherein the lens assembly is at least partially fixed within the carrier module of the actuator;
An image sensor in a fixed position relative to the housing of the actuator, wherein one or more lenses of the lens assembly are configured to direct external light through a hole and reach the image sensor surface;
Wherein, the camera is configured to, when the electric current passed from the driver circuit to the wire coil is adjusted, move the optical axis along one or more lenses and an optical axis of the image sensor A carrier module and the lens assembly to adjust the focus;
One or more processors; and
One or more computer-readable media storing instructions that, when executed by the one or more processors, are configured to provide a camera application that uses the camera to capture an environment in the camera A digital image of the scene and providing the image for display on the electronic display.

15. The computing device of claim 14, wherein the computing device is a smartphone, a tablet computing device, or a notebook computer.

16. The computing device of claim 15, wherein the computing device is a smart phone including the electronic display on a front face of the smart phone, and wherein the camera serves as a front of the smart phone. A camera is embedded in the smartphone.

17. A method for actuating a lens assembly in a camera, the method comprising:
The driver circuit receives a control signal from the controller, the control signal causes the driver circuit to excite the voice coil motor of the camera, the voice coil motor includes a permanent magnet and an electromagnet with a wire coil, the permanent magnet is located at On a first lateral side of a carrier module supporting the lens assembly, the wire coil is located on or along a first lateral side of a housing slidably receiving the carrier module. Side, the first lateral side of the carrier module is adjacent to the first lateral side of the housing, so that the permanent magnet and the wire coil are positioned adjacent to each other, and the driver circuit is electrically coupled To the wire coil and located on or along a second lateral side of the housing opposite to the first lateral side of the housing;
Responsive to receiving the first signal that will cause the driver circuit to excite the voice coil motor of the camera, a current is passed from the driver circuit to the wire coil to generate a connection with the wire coil. A first magnetic field interacting with a second magnetic field of the permanent magnet; and
The lens in the camera is actuated as a result of passing the current from the driver circuit and passing through the wire coil to generate the first magnetic field that interacts with the second magnetic field of the permanent magnet An assembly comprising sliding the carrier module a positive distance along the optical axis of the camera within the housing.

18. The method of claim 17, further comprising:
Detecting the current position of the carrier module within the housing using a position sensor located on or along the lateral side of the housing; and
It is determined whether to activate the voice coil motor of the camera based on the current position of the carrier module in the housing and the focusing objective of the camera.

19. The method of claim 17 or claim 18, wherein the camera is embedded in a display component of a smartphone, tablet computing device, or notebook computer.

20. The method according to any one of claims 17 to 19, wherein the lens is actuated by sliding the carrier module by the positive distance along the optical axis of the camera within the housing. The component causes movement of one or more lenses of the lens assembly toward or away from the image sensor of the camera, thereby adjusting the focus of the camera.
